(19) United States
(12) Patent Application Publication
(10) Pub. No.: US 2006/0222266 A1
(43) Pub. Date: Oct. 5, 2006

(54) Method of and apparatus for forming a final image sequence

(76) Inventors: Francois Bernard Lauze, Copenhagen (DK); Sune Hogild Keller, Vanlose (DK); Mads Nielsen, Dragor (DK)

Correspondence Address: HARNESS, DICKEY & PIERCE, P.L.C., P.O. BOX 8910, RESTON, VA, 20195, US

(21) Appl. No.: 11/239,697

(22) Filed: Sep. 30, 2005

Related U.S. Application Data
(60) Provisional application No. 60/614,420, filed on Sep. 30, 2004.

(51) Int. Cl. G06K 9/32

(52) U.S. Cl. 382/299

(57) ABSTRACT

A method of and apparatus for forming a final image sequence from an initial image sequence by adding new pixels to the original image sequence is disclosed. An energy of the final image sequence and its displacement field is defined in terms of one or more of (i) the local spatial distribution of pixel information of at least one pixel, (ii) the local temporal distribution of pixel information of at least one pixel, and (iii) the local spatial distribution of at least one displacement field between two images of said successive images that are displaced in time and the local spatial distribution of pixel information and displacement fields at the position in neighbouring images to which the displacement vector of a new pixel is pointing. The final image sequence is determined by finding a minimum or nearly-minimum of said energy.

This application claims the benefit of priority to U.S. application Ser. No. 60/614,420 the content of which is hereby incorporated by reference.

The present invention relates to a method of and apparatus for forming a final image sequence method, which is formed of a plurality of successive images, from an initial image sequence, which is formed of a plurality of successive images, by adding new pixels to the original image sequence. Typically, information is added to frames or fields in a video sequence, and/or new frames are created, in order to increase the resolution, in time and/or space, of the video sequence.

Video image sequences are generally transmitted either as frames or fields. When transmitting frames, a plurality of frames are transmitted each comprising image information relating to the whole of the area of the scene of the image. The frames are provided successively in time and in a predetermined order. When transmitting fields, the fields comprise only part of the information of the full image to be provided; the fields are interlaced. Interlacing means that each field comprises a number of rows of the full image, but there may be any number of missing lines/rows between rows of an interlaced field. Then, the full image is provided by providing, in a predetermined timed order, a number of fields each having different lines, shortly after each other, so that upon viewing the order of fields, the full image is provided. Typically, each frame is composed of two fields, the two fields respectively providing the odd and even lines of the image in the frame.

Increasing the resolution of each image in a video sequence facilitates a better viewing of the image at a higher resolution, at least when a high quality conversion method is used. Increasing the time resolution means that additional frames or fields are provided between the existing frames and fields. This may be used for providing a better “super slow” viewing of the image sequence or the viewing of the image sequence on a higher frequency monitor.

A number of arrangements exist for increasing the resolution of images/frames/fields or increasing the number of images/frames/fields. For example, line doubling (LDB) is a very simple deinterlacing algorithm. Every interpolated horizontal line is a repetition of the previous existing line. Line averaging (LAV) is a vertical average of the above and below pixels, since they are both known. Field insertion (FI), also known as merging or weaving, fills in the blanks with neighbouring lines in time and is essentially a temporal version of LDB. The result is very similar to the image seen on an interlaced display. Field averaging (FAV) is a temporal version of LAV, while vertical temporal interpolation (VT) is a simple 50/50 combination of LAV and FAV. All schemes mentioned so far are fixed, linear filters, whereas the next five are non-linear and adapt to certain conditions in their local neighbourhood and choose one of several possible interpolations depending on the local image content to yield better results. Median filtering (Med) is a classic in image processing and is used for deinterlacing in many variations. Motion adaptive deinterlacing (MA) can be done in many different ways. For example, it does simple motion detection and takes advantage of the qualities of simpler schemes under different conditions: FAV in the presence of no motion, median filtering when motion is slow, and LAV when fast motion is detected. Thresholds classify the motion. Weighted vertical temporal deinterlacing (WVT) is a simpler way of doing motion adaptation than the previous mentioned scheme, MA, and gives, instead of a hard switching between schemes, a smooth weighted transition between temporal and vertical interpolation. Edge adaptive deinterlacing (EA) has been suggested in several forms. However, all of these techniques have their own drawbacks. For example, each of these techniques can only be used for deinterlacing. Moreover, none of these techniques takes into consideration the nature of what image sequences actually are.

According to a first aspect of the present invention, there is provided a method of forming a final image sequence, which is formed of a plurality of successive images, from an initial image sequence, which is formed of a plurality of successive images, by adding new pixels to the original image sequence, the method comprising:

defining an energy of the final image sequence and its displacement field in terms of one or more of (i) the local spatial distribution of pixel information of at least one pixel, (ii) the local temporal distribution of pixel information of at least one pixel, and (iii) the local spatial distribution of at least one displacement field between two images of said successive images that are displaced in time and the local spatial distribution of pixel information and displacement fields at the position in neighbouring images to which the displacement vector of a new pixel is pointing; and,

determining the final image sequence by finding a minimum or nearly-minimum of said energy.

It has been found that determining the final image sequence by finding a minimum or nearly-minimum of the energy results in better image quality using a deterministic method that can be carried out quickly and effectively in real-time. This is in contrast to prior art methods, which typically proceed directly by considering only the neighbourhood of pixels in a rather localised and narrow manner. The present invention takes into consideration the nature of what an image sequence actually is and is therefore generic and can be used for one or more of spatial super resolution, temporal super resolution and deinterlacing. “Pixel information” in the present context includes or consists of pixel intensity and/or colour. The frame may be in grey scale, whereby the pixel information is a grey scale or intensity, or it may be in colour, whereby the pixel information may be a RGB colour or a colour/intensity represented in any other suitable manner, e.g. YCrCb or YUV. In this context, displacement, which is also known as optical flow, refers to the differences between consecutive frames in an image sequence. This is not due only to actual motion of objects in the image sequence, but rather refers to apparent motion, which may arise from actual motion and/or camera movement and/or changes in lighting, etc. The concept of “energy” of an image or image sequence is known per se and will be discussed further below. In general, any number of new pixels may be added and they may be added at any position, depending largely on the computational power of the one or more processors or the like in which the method is typically embodied.

The method allows pixel information and displacement vectors for the new pixels to be calculated, and allows them to be calculated simultaneously (though simultaneous calculation is not required).

Image sequences are typically in the form of frames. A frame is a single image or element in the video stream, which may be displayed on a computer monitor or other display device such as a high definition display such as a flat screen television (e.g. LCD or plasma display panels, projectors, etc.). A frame normally has a plurality of positions divided into rows and columns.

It will be understood that mathematically, ideally a true minimum of the energy is found. However, in practice, and particularly in order to keep down the processing time required to carry out the method, a sub-optimal variation of the method can be carried out in which points close to a true minimum (a “nearly-minimum”) are identified.

Depending on the embodiment, pixel information can be obtained from within the current frame and/or from one or more frames that precede or follow in time the current frame. Depending on the embodiment, displacement values can be obtained from one or more frames that precede or follow in time the current frame. Where data is obtained from preceding or following frames, this will typically be taken from positions in the preceding or following frames at which the displacement vector for the pixel concerned is pointing.

In an embodiment, the energy of the final image sequence is defined in terms of functionals of one or more of (i) the local spatial distribution of pixel information of at least one pixel, (ii) the local temporal distribution of pixel information of at least one pixel, and (iii) the local spatial distribution of at least one displacement field between two images of said successive images that are displaced in time and the local spatial distribution of pixel information and displacement fields at the position in neighbouring images to which the displacement vector of a new pixel is pointing, the determining step comprising finding a minimum or nearly-minimum of said functionals.

A functional is like a function except that its argument is itself a function. Thus, in the present context, pixel information and displacement fields and vectors are functions. The use of said functionals in this preferred embodiment provides a tool for finding a minimum or nearly-minimum of the energy of the image sequence.

The determining step may be carried out iteratively in which pixel information calculated at a pixel in one iteration is used in the calculation of displacement at said pixel in a subsequent iteration, and displacement calculated at a pixel in one iteration is used in the calculation of pixel information at said pixel in a subsequent iteration.

Said two images of said successive images that are displaced in time are preferably consecutive images.

In an embodiment, the method comprises:

determining pixel information and displacement values for said new pixels by:

first estimating an initial value of pixel information and displacement values for said new pixels, and estimating displacement values for pixels in the original image sequence; and,

subsequently obtaining new values of pixel information u and displacement values v for said new pixels by iterating:
u(τ+1)=fᵤ and
v(τ+1)=fᵥ
for said new pixels, where:

τ is an iteration parameter,

u is pixel information at a pixel,

v is a displacement vector at a pixel describing relative motion between an image in the final image sequence and one or more previous and/or later images in the final image sequence, and

fᵤ and fᵥ are solvers for the equation defining the energy of the final image sequence.

The initial value of the pixel information and displacement values may be derived from existing or known pixel information, e.g. in a neighbouring area of the frame, or may simply be predefined information given as an estimate of the values. In practice, these values are altered during the iteration, so that the actual initial information selected may not be particularly important, though a good choice will lead to more rapid convergence to the optimal final result. By iterating and updating the pixel information and displacement effectively in parallel, more precise results are obtained because information about each part of the image flows in time along the trajectories of the image motion and thus gives more information during the iteration.

Previous and/or later images are images provided earlier or later in the time dimension of the image sequence than the present image. The iteration starts with the existing information and the initial values at the new pixels and ends when, normally, a predetermined criterion is fulfilled. This criterion may be that a predetermined number of iterations has been performed or that a given stability of the calculated values is determined.

The pixel information may be estimated/iterated for each new pixel alone, or the iteration may be performed for all new pixels in an image, or in plural images, at the same time. Thus, when the iteration parameter τ changes, a new value of u and/or v may be determined for all new pixels in the image(s).

In an embodiment, for at least one of the new pixels:

fᵤ determines the u(τ+1) value on the basis of one or both of:
(i) values of u for one or more original pixels and/or new pixels within a predetermined area in the current image that includes the position of said at least one of the new pixels, said values of u for the original and new pixels being selected from values of u(τ) and/or u(τ+1), and
(ii) values of u for one or more original pixels and/or new pixels within a predetermined area in one or more previous and/or later images of the image sequence, said predetermined area including a position displaced by v(τ) or v(τ+1) in relation to the position of said at least one new pixel in the current image, said values of u for the original and new pixels being selected from values of u(τ) and/or u(τ+1); and

fᵥ determines the v(τ+1) value on the basis of one or both of:
(i) values of u and v for one or more original pixels and/or new pixels within a predetermined area in the current image that includes the position of said at least one of the new pixels, said values of u and v for the original and new pixels being selected from values of u(τ) and/or u(τ+1) and v(τ) and/or v(τ+1) respectively, and
(ii) values of u and v for one or more original pixels and/or new pixels within a predetermined area in one or more previous and/or later images of the image sequence, said predetermined area including a position displaced by v(τ) or v(τ+1) in relation to the position of said at least one new pixel in the current image, said values of u and v for the original and new pixels being selected from values of u(τ) and/or u(τ+1) and v(τ) and/or v(τ+1) respectively.

In general, depending on the embodiment, old data (i.e. u(τ) and v(τ)) from a previous iteration or new data from the current iteration (i.e. u(τ+1) and v(τ+1)) may be used in the iteration, and may be used in any combination. In general, depending on the embodiment, the data used in the iteration may be for existing pixels in the original image sequence or data for new pixels added by the method, which again may be used in any combination.

When the iteration comprises iterating both the pixel information and the displacement, as is most preferred, a better estimate of the pixel information at the new pixel is obtained because there is better coherence between the calculated pixel information and displacement values.

In the present context, the “predetermined area”, from which pixel information may be used for determining the u and v values, may be selected in any suitable manner. For example, the predetermined area may be based on points in the current image spatially not too far away from the position in question, to avoid the risk that the u and/or v value is based on information not related to the part of the image represented by the present position. The predetermined area may similarly be in parts of images displaced in time from the current image (i.e. previous or later images), said parts being around the position to which the displacement vector of the pixel in the current image points.

Pixel information values for pixels in the original image sequence may be adjusted by iterating:
u(τ+1)=fᵤ

for said pixels in the original image sequence.

Displacement values for pixels in the original image sequence may be adjusted by iterating:
v(τ+1)=fᵥ

for said pixels in the original image sequence.

Thus, the method may be used to update pixel information and/or displacements values for “old” pixels, i.e. pixels already in the original image sequence, in addition to calculating the relevant values for the new pixels added to the original image sequence to create the final image sequence. Depending on the image and the purpose of carrying out the method, this can lead to better image quality.

In an embodiment, it is assumed that v=0, so that u(τ+1)=fᵤ is iterated. This situation is encountered when no movement or no significant movement is detected, or when motion calculation is too expensive or complex or does not provide any additional information. This is mainly of application to the so-called spatial super resolution and de-interlacing embodiments.

Otherwise, in general, the determining may include calculating at least one of (i) a displacement vector at a pixel, (ii) a displacement vector at a group of pixels, and (iii) a displacement field, said displacement vector or displacement field describing relative motion between an image in the final image sequence and one or more previous and/or later images in the final image sequence.

In an embodiment, u(τ+1)=fᵤ is iterated a number of times whilst holding fᵥ constant and v(τ+1)=fᵥ is iterated a number of times whilst holding fᵤ constant. This is useful in the situation where it is desired to iterate only the u or v value a number of times between iteration of the other value. This may be the situation when either fᵤ or fᵥ needs smaller time steps than the other to compute correctly, or when an update of for example v is only needed for every n^{th} (n>1) iteration of fᵤ to produce an optimal output. In order not to iterate the current u or v value, the method may thus be adapted to output the same value for u or v respectively as long as τ is within the interval during which the other value is iterated. These intervals may be recurring, so that fᵤ and/or fᵥ each is adapted to output a new value for every n^{th} iteration, such as every second, third, fourth, fifth, . . . tenth, twentieth iteration of τ. Naturally, n may be different for fᵤ and fᵥ. The calculations of u and v may be carried out for example on parallel processors, or in parallel threads within the same processor.

In an embodiment, the successive images of the final and original image sequences are in the form of frames, and new pixels are added to at least one of the frames of the original image sequence to form a frame of the final image sequence having a greater number of pixels than said at least one of the frames of the original image sequence. This embodiment can thus be used to increase the spatial resolution of one or more images in an image sequence and is therefore termed “spatial super resolution”. This has many applications. For example, it can be used to increase the resolution of medical images. As another example, it can be used in so-called video upscalers, which are used to increase the resolution of images from any source, including for example digital television signals received over the air, via satellite or cable, video signals from game consoles, etc. This is of particular interest at present in order to improve the resolution of such signals for driving plasma display panels and other large and/or widescreen display devices.

In general, the new pixels may be positioned anywhere in the image(s), whether in existing rows and columns of the original images or in new rows and/or columns placed between the existing rows/columns. Indeed, it may be that none or few of the original pixel values and pixel positions are retained in the final image. In general, the aspect ratio of the original image will be retained, but this is not necessarily the case.

In an embodiment, the successive images of the final and original image sequences are in the form of frames, and new pixels are used to create a new frame of the final image sequence in which the new frame is between frames of the original image sequence. This embodiment can thus be used to increase the temporal resolution of an image sequence and is therefore termed “temporal super resolution”. This has many applications. For example, it can be used to provide for super-slow motion playback of the image sequence. It can also be used to increase the temporal resolution, which can be used to increase the effective frequency of the video signal. This may be used for example for converting a 50/60 Hz signal into a 100/120 Hz signal or any other frequency higher than that of the input sequence. In either creating slow motion or increasing the frame rate, the preferred method will produce smoother, more natural and less jerky motion during playback.

In an embodiment, the successive images of the final image sequence are in the form of frames and the successive images of the original image sequence are in the form of fields, and wherein new pixels are grouped in new rows placed in between rows of fields of the original image sequence to create corresponding frames in the final image sequence. This embodiment can thus be used to carry out de-interlacing, i.e. to form a frame from a field by creating new pixels to fill in the “missing” rows of the field.

Naturally, the above embodiments may be combined in any combination. Thus, for example, the method may be used simultaneously to increase both the temporal and spatial resolution of an image sequence. As another example, the conversion of an interlaced signal may be preceded or succeeded by an increase in temporal and/or spatial resolution.

In one embodiment, one iteration of u(τ+1) and v(τ+1) is run for each new pixel in a frame or each pixel in a new frame, or one iteration of v(τ+1) is run for each original pixel, before performing the next iteration step on any new pixel. In this manner, a number of new pixels are calculated simultaneously in the sense that when the iteration of the first of these new pixels has finished, the other new pixels are in the process of being iterated. Then, the method may even be performed on a plurality of the frames, wherein one iteration of u(τ+1) and v(τ+1) is run for each new pixel in each of the plurality of frames or fields or is run for each new pixel in a plurality of the frames. Thus, a number of frames or fields may be processed at the same time. Then, having finished the calculation, one or more of the frames/fields may be output (as being finished), and one or more new frames/fields may be introduced, initialised and subsequently take part in a renewed calculation with the new frames/fields and some of the frames/fields taking part in the former calculation. In this manner, a certain coherence is obtained in the process over time.

In one embodiment, no change is made to the information in the plurality of positions of the frame(s) and/or fields that had information before the initialization (the existing information in the existing positions). In another embodiment, this information is altered. This altering may be a pre-calculation altering, such as a smoothing of the frame/field information in order to prepare the information for calculation. Another type of altering is a pre-calculation, simultaneous or post-calculation de-noising as is known per se.

According to a second aspect of the present invention, there is provided apparatus for forming a final image sequence, which is formed of a plurality of successive images, from an initial image sequence, which is formed of a plurality of successive images, by adding new pixels to the original image sequence, the apparatus comprising:

one or more processors arranged to define an energy of the final image sequence and its displacement field in terms of one or more of (i) the local spatial distribution of pixel information of at least one pixel, (ii) the local temporal distribution of pixel information of at least one pixel, and (iii) the local spatial distribution of at least one displacement field between two images of said successive images that are displaced in time and the local spatial distribution of pixel information and displacement fields at the position in neighbouring images to which the displacement vector of a new pixel is pointing; and to determine the final image sequence by finding a minimum or nearly-minimum of said energy.

The apparatus may be embodied as one or more processors. The or each processor may be a general purpose processor which is programmed with appropriate software to carry out the method. The or one or more of the processors may be custom chips, such as ASICs (application-specific integrated circuits) or FPGA (field-programmable gate array) devices, that are specially adapted to carry out the method.

Preferred embodiments of the apparatus correspond to the preferred embodiments of the method as described above.

Embodiments of the present invention will now be described by way of example with reference to the accompanying drawings, in which:

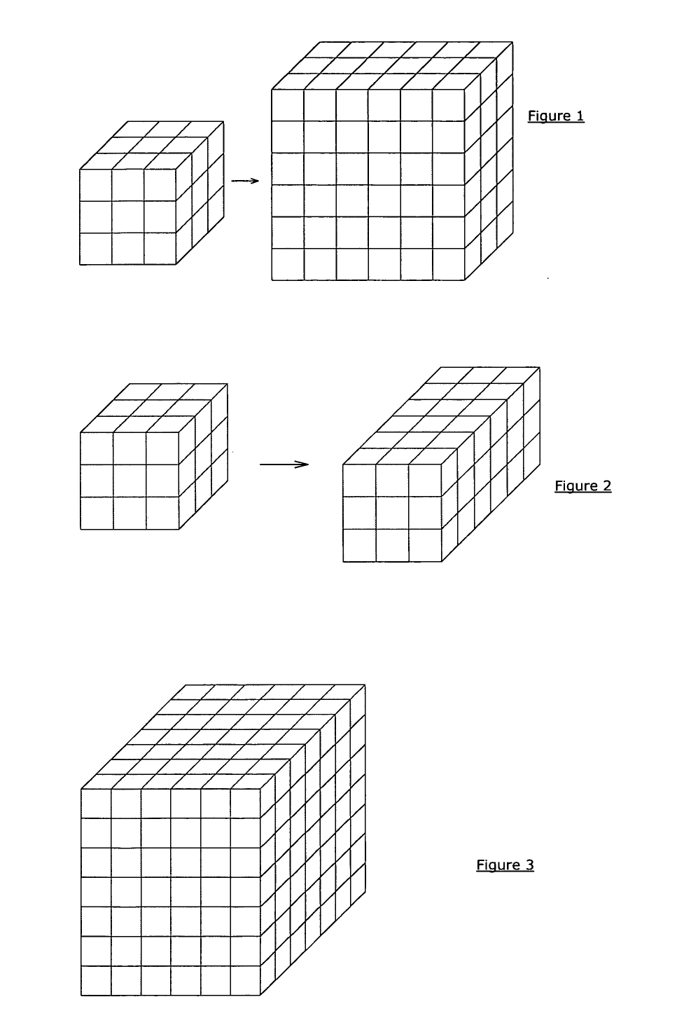

FIG. 1 illustrates schematically spatial resolution enhancement;

FIG. 2 illustrates schematically temporal resolution enhancement; and,

FIG. 3 illustrates schematically deinterlacing.

In general, the preferred embodiments of the present invention may be used for increasing the resolution of a sequence of images spatially or temporally or both.

A first example is for super resolution in space, e.g. doubling or otherwise increasing the spatial resolution in the height and width (m,n) of each image in the sequence, but not modifying the number t of frames:
(m,n,t)→(2m,2n,t)
or, more generally, (m,n,t)→(k·m,l·n,t), where k and l are any real positive numbers (not necessarily integers).

This is illustrated schematically in FIG. 1, where all shaded pixels are available in the input and all the white pixels are to be calculated for the output.

A second example is for temporal super resolution, e.g. by doubling the number of images in the sequence:
(m,n,t)→(m,n,2t)
or, more generally, (m,n,t)→(m,n,k·t), where k is any real positive number.

This is illustrated schematically in FIG. 2. The extra frames created can be used to make the sequence longer (to create “super slow motion”) or to increase the rate of frames shown per second.

A third example is deinterlacing as illustrated schematically in FIG. 3. Deinterlacing can be seen as a temporal and/or spatial resolution increase. In a typical interlaced sequence, each of the two fields of a frame has only every other line of the frame (i.e. one field has even numbered lines only and the other field has odd numbered lines only). Again all the white pixels in FIG. 3 need to be calculated.

In broad terms, the present preferred process is to calculate the new pixels needed, normally keeping the original pixels. For that purpose, pixel information (intensities) and displacement field values are calculated for the new pixels. In most cases the displacement field values are also calculated for the original pixels. In some circumstances, however, the pixel information values for original pixels may also be adjusted, leading to better image quality than otherwise.

These calculations can be done in numerous ways. In accordance with the preferred embodiment, a model of an image sequence is formulated and expressed as one or more equations giving the “energy” of the image sequence in terms of the pixel information (grey level intensities or colour values) and/or displacement values. The concept of energy of an image and image sequence is known per se. In the present context, it has its roots in the use of Bayes' Theorem to formulate the probability of a desired (final) output image sequence given an input (original) image sequence and a chosen model or set of models of image sequences and displacements. The process of maximising this probability, which is the desired goal to produce the final image sequence, can be reformulated as the process of minimising the energy. In the preferred embodiment described herein, the energy of the image sequence is given in the form of a functional of the pixel information (grey level intensities or colour values) and the displacement field. In this functional there are given models in the form of mathematical and statistical (sub)functionals of what an image sequence and its displacement fields should look like. These models are used to find the best or good (sub-optimal) estimates of pixel information in the new pixel positions and displacement values for all pixels positions in an image sequence. Inevitably, there is a trade-off between obtaining the best possible image quality to the human visual system (i.e. detailed but without artifacts stemming from the up-scaling process) and mathematical tractability (which in practice is necessary, especially as the theoretical formulation cannot be implemented in practice as it has no numerical counterpart. Moreover, of course, the method has to be embodied in apparatus, such as an upscaler or general purpose computer, which inevitably has practical constraints on its processing power and the like.

The following notation will be used:
u₀ the known pixel values and K their locations (the shaded ones in the illustrations) in the new resolution settings,
u the sequence to be created,
uₛ a local spatial distribution (the neighbourhood of each pixel within the same frame) for u,
uₜ a local temporal distribution (the neighbourhood of each pixel in the previous following frames) for u and
\vec{v} the field of displacement between two consecutive frames (also known as the optic flow, as discussed above).

In one embodiment, the (up-scaled) final output image sequence u and its corresponding displacement field \vec{v} are computed as (suboptimal) minimizers of the constrained energy:

$$\{ \begin{matrix} E \text{(} u , {v}^{->} \text{)} = {E}_{1} ( {u}_{s} ) + {E}_{2} \text{(} {u}_{s} \cdot {u}_{t} , {v}^{->} \text{)} + {E}_{3} \text{(} {v}^{->} \text{)} \\ u {\vert}_{K} = {u}_{0}\end{matrix} \qquad ( 1 )$$

where E₁(uₛ), E₂(uₛ,uₜ,\vec{v}) and E₃(\vec{v}) each help model image sequences and displacements. The second line in equation (1) reflects the fact that modelling of pixel information is only to be imposed in new pixel positions while the values in original pixel positions (i.e. of pixels in the original image sequence) are retained. The displacement field is modelled in all pixel positions, new and original.

E₁(uₛ) punishes too large local spatial variations in each frame as large local variations in pixel information values is the prevalent feature of noise and thus not desirable.

E₁(uₛ) tries to pull pixel information in new pixel positions in the direction of smooth images. Choosing a good functional for the E₁ term allows smooth regions and edges as long as they are not too large in variation.

The last term E₃(\vec{v}) enforces a reasonable local smoothness for the displacement field. It is assumed that the displacement in the image sequence is caused by an object moving so that each pixel does not necessarily have an individual displacement but will have a displacement similar to the that of (some of) its neighbours as they represent different parts of the same object. The functional used on the displacement field in E₃(\vec{v}) is often the same used on the pixel information in E₁(uₛ) as there are edges in the displacement field between regions or objects moving differently just as there are edges in the pixel information.

In general, E₂(uₛ.uₜ,\vec{v}) is the most complex of the three terms. It links local spatial and temporal sequence content with the image sequence displacement field \vec{v} and conversely links \vec{v} to the image sequence content, penalizing large discrepancies. This term works both on the pixel information and the displacement. It is a representation of the well-known Optical Flow Constraint (OFC) stating that the pixel information should stay the same along the displacement field. To allow for changes in lighting and disocclusions (i.e. where one object moves behind another and disappears), edges in time in the displacement fields should be allowed.

It is desired to model an image sequence that is a recording of the real world, where coherence, order and causality exist. Minimizing the energy means that the image sequence should obey the constraints imposed on it by equation (1). (In practice, owing for example to technical constraints in the apparatus carrying out the process, it is not always possible to obtain the optimal solution (with minimal energy) so the one closest to is used, i.e. the suboptimal solution.)

Alternatively, it may be desirable to add de-noising to the resolution enhancement by computing minimizers of the unconstrained energy:
E(u,\vec{v})=E₀(u,u₀)+E₁(uₛ)+E₂(uₛ.uₜ,\vec{v})+E₃(\vec{v}) (2)
where the term E₀(u,u₀) allows deviation from the original values u₀, but penalizes too large deviations. De-noising by adding the term E₀(u,u₀) simply helps clean up the image sequence and equation (2) may be used instead of equation (1) if the input sequence is very noisy or generally smooth images are desired. Adding the term E₀(u,u₀) will in most cases not only de-noise but also smooth out details.

This technique using energy minimization as in equation (1) and (2) has so far been used for the image sequence restoration technique known as inpainting to repair blotches, scratches and other damage on digitized films (such as movies and medical scans), in which damaged pixels are repaired. See for example Lauze, F. and Nielsen, M.: A Variational Algorithm for Motion Compensated Inpainting, in BMVC, vol. 2, pages 777-787, editors: A. Hoppe, S. Barman and T. Ellis, BMVA, 2004, the content of which is hereby incorporated by reference. However, it has to the best of our knowledge not been used for upscaling as proposed herein, in which new pixels are created and added to images.

Choice of Functions/Functionals for the Terms Eᵢ=0, 1, 2, 3

To minimize the energy, an iterative technique is preferred, but first functions or functionals for the terms Eᵢ=0, 1, 2, 3 are selected in accordance with the preferred embodiment. The functions or functionals need to be good estimates of the image sequences and displacements concerned (typically being projected recordings of the real world, including physical motion and changing lighting conditions), but at the same time be mathematically tractable. To suit these purposes, various alternatives for both u and \vec{v} may be used. Examples include:

Gaussian (harmonics):
E₁=λ₁∫|∇u|²dx (3)
E₂=λ₂∫|\overline{v}∇u+uₜ|²dx (4)
E₃=λ₃∫(|∇v₁|²+|∇v₂|²)dx (5)
where \vec{v}=(v₁,v₂)^{T} and ∇ denotes the spatial gradient and uₜ is the first derivative of u with respect to time, t.

Gaussians impose smoothing on both the intensities (u) and the displacement (\vec{v}). Smoothness is a generally desirable and aesthetically pleasing property in an image except at edges (the edges being edges in intensity and in the displacement between objects moving differently).

More generally, the exponent, 2, in all three examples above (equations (3)-(5)) can be replaced by α, e.g.:
E₁=λ₁∫|∇u|^{α}dx (6)

The case where α=1 is called total variation, and is very interesting as it possesses the same smoothing properties as the Gaussians, but by allowing larger variations it also preserves edges by lowering the smoothing across edges but still allowing smoothing along the edges. This property ensures a good continuation of edges through new pixel positions when doing up-scaling.

A possibility, and sometimes a must, is to use a regularization of the gradient magnitude, e.g. |∇u|, because the abs-function (|•|) is not differentiable at the origin, and the differentiability is a desired property:

$${E}_{i} = {λ}_{i} \int φ ( {\vert ∇ u \vert}^{2} ) ⅆ x , \\ φ ( {s}^{2} ) = \sqrt{{s}^{2} + {ɛ}^{2}} or φ ( {s}^{2} ) = log ( {s}^{2} + ɛ ) \\ strictly convex non convex \qquad ( 7 )$$

where ε has a small value, such as 0.1 or 0.001 for example.

All these examples are rather simple functions, a more complex example is:
E₂=∫(φ[u(x+\vec{v})−u(x)]²+γ|∇u(x+\vec{v})−∇u(x)|²)dx (8)
where γ is a constant and x denotes spatio-temporal coordinates (x,y). Again, see for example Lauze, F. and Nielsen, M.: A Variational Algorithm for Motion Compensated Inpainting, in BMVC, vol. 2, pages 777-787, editors: A. Hoppe, S. Barman and T. Ellis, BMVA, 2004.

In some cases (especially concerning the calculations of the displacement) u may be replaced by u_{σ}, the image pre-smoothed by convolution with a Gaussian kernel. This is done to get a more accurate and smooth displacement field and can give significant improvements.

Typical Way of Minimizing the Energy

In one preferred embodiment, the energy functional (which is an integral equation) is turned into a set of partial differential equations (PDE) named Euler-Lagrange equations (EL) by the use of calculus of variations:

$$\{ \begin{matrix}\frac{\partial E}{\partial u} = 0 \\ \frac{\partial E}{\partial {v}^{->}} = 0\end{matrix} \qquad ( 9 )$$

The derivation of Euler-Lagrange equations is a well-known technique but becomes increasingly difficult when the energy functionals become more complex, like the one given in equation (8). The choice of optimization strategy (solving the Euler-Lagrange equations) partially depends on the different terms in

$$\frac{\partial {E}_{i}}{\partial u}$$

and

$$\frac{\partial {E}_{i}}{\partial {v}^{->}}$$

but also the shape of the loci of the new pixels. (Spatial super resolution, deinterlacing, and temporal super resolution/super slow have different loci, the loci being the local organization of new and original pixel positions with respect to each other.) Typically, however, it can be done by minimization of the Euler-Lagrange equations' corresponding Gradient Descent equations, which then becomes the iterative step mentioned above. Other methods of solving the Euler-Lagrange equations are Jacobi solvers, Gauss-Seidel solvers or SOR solvers. All three are direct solvers, solving a linear system using fixed point iterations to get values for the possible non-linear elements of an Euler-Lagrange equation. It is also possible to use the less known multigrid solvers.

In general terms, one example of the iterative process can be described as:
u(τ+1)=fᵤ(u(τ),\vec{v}(τ))
\vec{v}(τ+1)=f_{\vec{v}}(u(τ+1),\vec{v}(τ)) (10)
where τ is the evolution time of the algorithm (to distinguish it from the temporal dimension t of the sequence, as these two are completely different parameters). fᵤ and f_{\vec{v}} are solvers, e.g. PDE solvers as the gradient descent, that compute improved updates of the intensities and displacement field of the sequence. So for each increment of τ in the sequence, the energy of the sequence in equation (1) is updated ultimately to minimize the energy and thus the quality of the image is enhanced.

It should be noted that the example of the iterative process mentioned above uses u(τ) and v(τ) (i.e. “previous” values for pixel information and displacement from the previous iteration) to find u(τ+1), and u(τ+1) and v(τ) (i.e. the current iterated value for pixel information and the previous value for displacement) to find v(τ+1). However, in general, in the iterative process to find u(τ+1) and v(τ+1), any of u(τ), u(τ+1), v(τ) and v(τ+1) may be used, and these may be used interchangeably and variously through the iteration process. Say one iterates through an image row by row from top to bottom, in each row going through each pixel from left to right. Then for any neighbouring pixel above or before in the current row you can use either u(τ), u(τ+1), v(τ) or v(τ+1) values, but for the later and lower neighbours you can only use u(τ), or v(τ). To save memory one might overwrite the old values and thus only have u(τ+1) and v(τ+1) for the upper and left neighbours. One might iterate differently and one might use parallel processing, but no matter what, in general one can choose any values from the current (τ+1) or previous (τ) set of values that optimizes the end result.

At τ=0, it is necessary to initialize the new pixel positions, and the better it is done the faster an optimal result is obtained.

A simple example of an Euler-Lagrange equation is, given that \vec{v}=0 and using total variation: energy formulation

$$\{ \begin{matrix} E ( u ) = \frac{1}{2} \int φ ( {\vert ∇ u \vert}^{2} ) ⅆ x + \frac{α}{2} \int φ ( {u}_{t}^{2} ) ⅆ x , φ ( {s}^{2} ) = \sqrt{{s}^{2} + ɛ} \\ u {\vert}_{K} = {u}_{0}\end{matrix} \qquad ( 11 )$$

resulting in the EL-Equation:

$$\frac{\partial E}{\partial u} = - div ( \frac{∇ u}{φ ( {\vert ∇ u \vert}^{2} )} ) - α {\partial }_{t} ( \frac{{u}_{t}}{φ ( {\vert {u}_{t} \vert}^{2} )} ) = 0 , \qquad ( 12 )$$

div is the divergence in 2D (x,y) known from physics and ∂ₜ is the divergence in 1D (time). This kind of scheme is called motion adaptive as it adapts to motion. Due to the denominators in equation (12), smoothing across edges will be minimized. For the first term in the middle part of equation (12), the spatial part will stop smoothing across edges in each frame because of the denominator, as it is in essence the gradient magnitude, the most commonly used edge detector in image processing. For the second term in the middle part of equation (12), the temporal divergence, the denominator will be small when there is no or very small motion in the image sequence and thus allows smoothing in time, but the denominator will be large in the presence of motion and thus stops smoothing in time and only allows spatial smoothing. This gives rise to the notion of “motion adaptive”. Reference is made in this regard to the paper by Sune Keller, Francois Lauze and Mads Nielsen: “A Total Variation Motion Adaptive Deinterlacing Scheme”, published in: “Scale Space and PDE Methods in Computer Vision”, editors: Ron Kimmel, Nir Sochen and Joachim Weickert, Springer, LNCS 3459, Berlin, 2005, the content of which is hereby incorporated by reference.

Minimization of this Euler-Lagrange equation can be used for deinterlacing and spatial super resolution (within limits), but not for temporal super resolution/super slow. In the first two cases there are some original pixel positions within the current frame from which data can be obtained when the temporal smoothing switches off due to motion. This is not possible for the third case as all pixel positions in the frames to be interpolated are new: if for example the camera is moving, then all positions have motion and no data will be propagated into the new frame.

The gradient descent equation corresponding to equation (12), which is to be discretized and solved iteratively, is:

$$\frac{\partial u}{\partial τ} = - \frac{\partial E}{\partial u} , i . e . \frac{\partial u}{{}^{\cdot } \partial τ} = div ( \frac{∇ u}{φ ( {\vert ∇ u \vert}^{2} )} ) - α {\partial }_{t} ( \frac{{u}_{t}}{φ ( {\vert {u}_{t} \vert}^{2} )} ) = 0 , \qquad ( 13 )$$

where τ is again the iteration/evolution time. This equation is then discretized using well known numerical schemes.

The discretization of the term div(f|∇u|) where f=1/φ(|∇u|²) and ∇u=(∂u/∂x,∂u/∂y)^{T}=(∂ₓu,∂_{y}u)^{T} will now be considered. Now by definition of the divergence, div(f|∇u|)=∂ₓ(f∂ₓu)+∂_{y}(f∂_{y}u). This expression can be rewritten as a finite difference schemes using the well-known Taylor's approximation for (partial) differential equations. The good thing about finite difference schemes is that they can be used directly on (digital) discrete image sequences.

The finite difference scheme looks like this:
div(f∇u)≈δ_{x,h/2}^{o}(fδ_{x,h/2}^{o}u)+δ_{y,h/2}^{o}(fδ_{y,h/2}^{o}u) (14)
where δ_{x,h/2}^{o} denotes the well known central difference scheme for the first derivative of u in the x-direction and the same for δ_{y,h/2}^{o} in the y-direction. h is the distance between two horizontally or vertically neighbouring pixel positions (grid points) and most often may be set to 1. The central difference is given like:

$${δ}_{x , h / 2}^{o} = \frac{u ( x + h / 2 , y , t ) - u ( x - h / 2 , y , t )}{h} \qquad ( 15 )$$

which can be derived from Taylor approximations (also known as Taylor expansions). Now information in points between grid points, where no information exists, is required. By rewriting equation (14) using equation (15):

$$div ( f ∇ u ) \approx \frac{1}{{h}^{2}} ( {f}_{i + 1 / 2 j} {u}_{i + 1 j} + {f}_{i - 1 / 2 j} {u}_{i - 1 j} + {f}_{ij + 1 / 2} {u}_{ij + 1} + {f}_{ij - 1 / 2} {u}_{ij - 1} ) - \frac{1}{{h}^{2}} ( {f}_{i + 1 / 2 j} + {f}_{i - 1 / 2 j} + {f}_{ij + 1 / 2} + {f}_{ij - 1 / 2} ) {u}_{ij} \qquad ( 16 )$$

where ij is a short form for the (x, y)-coordinates. Now only values for f=1/φ(|∇u|²) are needed at half grid points (i.e. between pixel positions), and thus need to be interpolated. Now consider f=1/|∇u|=1/\sqrt{(∂ₓu)²+(∂_{y}u)²}. (Using φ(s²)=\sqrt{s²+ε²} is equivalent to adding ε² in the square root.) Computing ∂ₓu at for example (x, y)=(i−½, j) is easy using equation (15) but the ∂_{y}u-term needs to be interpolated, for example by using equation (15) for the y-direction on both sides of the half grid point:

$${\partial }_{y} {u}_{i - 1 / 2 j} \approx \frac{\frac{{u}_{i - 1 j - 1} - {u}_{i - 1 j + 1}}{h} + \frac{{u}_{ij - 1} - {u}_{ij + 1}}{h}}{2} \qquad ( 17 )$$

Typically, h/2=½. Similar expressions can easily be found for the three remaining terms to get all four half grid point calculations of f in equation (16).

Using Taylor's approximation to arrive at numerical expressions can also be done for the remaining term in equation 13, ∂u/∂t and div(f|uₜ|) with f=1/φ(|uₜ|²) to get a complete discrete implementation of the problem.

Another and somewhat more complex example of an energy functional again using total variation but this time actually calculating the displacements is:

$$\{ \begin{matrix}\begin{matrix}E ( u , {v}^{->} ) = {λ}_{1} \int {φ}_{1} ( {\vert ∇ u \vert}^{2} ) ⅆ x + {λ}_{2} \\ \int {φ}_{2} ( {( \vert {v}^{->} \cdot ∇ u + {u}_{t} \vert )}^{2} ) ⅆ x + {λ}_{3} \\ \int ( {φ}_{3} ( {\vert ∇ {v}_{1} \vert}^{2} ) + {φ}_{3} ( {\vert ∇ {v}_{2} \vert}^{2} ) ) ⅆ x\end{matrix} \\ u {\vert}_{K} = {u}_{0 }\end{matrix} \qquad ( 18 )$$

where: φᵢ(s²)=\sqrt{s²+ε²}, ∇ is the spatial gradient operator, λᵢ>0 are some constants and v₁ and v₂ are the x and y components of the displacement field, i.e. \vec{v}=(v₁,v₂)^{T}. The first term in this energy is the same as the first term in the previous example given in equation (11).

The resulting EL equations are (one for u and a pair for each of the two components of the displacement field):

$$\begin{matrix}\begin{matrix}\frac{\partial E}{\partial u} = - {λ}_{1} {div}_{2} ( \frac{∇ u}{{φ}_{1} ( {\vert ∇ u \vert}^{2} )} ) - {λ}_{2} {div}_{3} \\ ( \frac{{φ}_{2}^{′} ( {\vert {v}^{->} \cdot ∇ u + {u}_{t} \vert}^{2} )}{\vert {v}^{->} \cdot ∇ u + {u}_{t} \vert} ( {v}^{->} \cdot ∇ u + {u}_{t} ) {V}^{->} ) \\ = 0\end{matrix} & ( 19 a ) \\ \{ \begin{matrix}\begin{matrix}\frac{\partial E}{\partial {v}_{i}} = - {λ}_{2} \frac{{φ}_{2}^{′} ( {\vert {v}^{->} \cdot ∇ u + {u}_{t} \vert}^{2} )}{\vert {v}^{->} \cdot ∇ u + {u}_{t} \vert} ( {v}^{->} \cdot ∇ u + {u}_{t} ) {u}_{i} - \\ {λ}_{3} {div}_{2} ( \frac{∇ {v}_{i}}{{φ}_{3} ( {\vert ∇ {v}_{i} \vert}^{2} )} ) \\ = 0\end{matrix} \\ i = 1 , 2\end{matrix} & ( 19 b )\end{matrix}$$

div₂ is the divergence in 2D (x,y) from earlier and div₃ is the divergence in 3D (x,y,t) and \vec{V}=(v₁,v₂,1)^{T}.

For the first term in the middle part of equation (19a), the spatial part will stop smoothing across edges in each frame because of the denominator, as mentioned in the discussion of equation (12). The same goes for the second term in the middle part of equation (19b) just for spatial edges in the displacement field that separates object or regions with different displacements. For the remaining some what more complex terms representing the OFC mentioned earlier, something similar happens for edges in time (e.g. occlusions) generally allowing propagation of information along the trajectory of the displacement.

Minimization of these Euler-Lagrange equations can be used for deinterlacing, spatial super resolution and temporal super resolution/super slow.

The gradient descent equations corresponding to equations (19a+b), which are to be discretized and solved iteratively, are:

$$\begin{matrix}\frac{\partial u}{\partial τ} = - \frac{\partial E}{\partial u} , i . e . \\ \begin{matrix}\frac{\partial u}{\partial τ} = {λ}_{1} {div}_{2} ( \frac{∇ u}{{φ}_{1} ( {\vert ∇ u \vert}^{2} )} ) + {λ}_{2} {div}_{3} \\ ( \frac{{φ}_{2}^{′} ( {\vert {v}^{->} \cdot ∇ u + {u}_{t} \vert}^{2} )}{\vert {v}^{->} \cdot ∇ u + {u}_{t} \vert} ( {v}^{->} \cdot ∇ u + {u}_{t} ) {V}^{->} ) \\ = 0\end{matrix} \\ and & ( 20 a ) \\ \frac{\partial {v}_{i}}{\partial τ} = \frac{\partial E}{\partial {v}_{i}} , i . e . \\ \{ \begin{matrix}\begin{matrix}\frac{\partial {v}_{i}}{\partial τ} = {λ}_{2} \frac{{φ}_{2}^{′} ( {\vert \vec{v} \cdot ∇ u + {u}_{t} \vert}^{2} )}{\vert \vec{v} \cdot ∇ u + {u}_{ t} \vert} ( \vec{v} \cdot ∇ u + {u}_{t} ) {u}_{i} + \\ {λ}_{3} {div}_{2} ( \frac{∇ {v}_{i}}{{φ}_{3} ( {\vert ∇ {v}_{i} \vert}^{2} )} ) \\ = 0\end{matrix} \\ i = 1 , 2\end{matrix} & ( 20 b )\end{matrix}$$

where τ is again the iteration/evolution time. This equation is then discretized using well known numerical schemes.

The first term in the middle part of equation (20a) is the same as the one from equation (13) and its discretization was given earlier. Using Taylor's approximation to arrive at numerical expressions can also be done for the vᵢ terms (second term in the middle part) of equation (20b), div₂(f|∇vᵢ|) where f=1/φ₃(|∇vᵢ|²) in a way very similar to the example given earlier. Details on this as well as descriptions on the somewhat more complex discretizations of the remaining two terms in equations (13a+b) can be found in the Ph.D. thesis of Francois Lauze entitled “Computational Methods for Motion Recovery, Motion Compensated Inpainting and Applications”, ITU, Copenhagen, Denmark, 2005 and the references therein, the content of which is hereby incorporated by reference.

The technique can be generalized and used for many versions of equation (1) and (2) with different functions used for the Eᵢ terms, when it can be rewritten as partial differential equations. This is due to the fact that Taylor approximations allow for discrete (finite) rewritings of (partial) differential equations.

Embodiments of the present invention have been described with particular reference to the examples illustrated. However, it will be appreciated that variations and modifications may be made to the examples described within the scope of the present invention.

1. A method of forming a final image sequence, which is formed of a plurality of successive images, from an initial image sequence, which is formed of a plurality of successive images, by adding new pixels to the original image sequence, the method comprising:
defining an energy of the final image sequence and its displacement field in terms of one or more of (i) the local spatial distribution of pixel information of at least one pixel, (ii) the local temporal distribution of pixel information of at least one pixel, and (iii) the local spatial distribution of at least one displacement field between two images of said successive images that are displaced in time and the local spatial distribution of pixel information and displacement fields at the position in neighbouring images to which the displacement vector of a new pixel is pointing; and,
determining the final image sequence by finding a minimum or nearly-minimum of said energy.

2. A method according to claim 1, wherein the energy of the final image sequence is defined in terms of functionals of one or more of (i) the local spatial distribution of pixel information of at least one pixel, (ii) the local temporal distribution of pixel information of at least one pixel, and (iii) the local spatial distribution of at least one displacement field between two images of said successive images that are displaced in time and the local spatial distribution of pixel information and displacement fields at the position in neighbouring images to which the displacement vector of a new pixel is pointing, the determining step comprising finding a minimum or nearly-minimum of said functionals.

3. A method according to claim 1, wherein the determining step is carried out iteratively in which pixel information calculated at a pixel in one iteration is used in the calculation of displacement at said pixel in a subsequent iteration, and displacement calculated at a pixel in one iteration is used in the calculation of pixel information at said pixel in a subsequent iteration.

4. A method according to claim 1, wherein said two images of said successive images that are displaced in time are consecutive images.

5. A method according to claim 1, comprising:
determining pixel information and displacement values for said new pixels by:
first estimating an initial value of pixel information and displacement values for said new pixels, and estimating displacement values for pixels in the original image sequence; and,
subsequently obtaining new values of pixel information u and displacement values v for said new pixels by iterating:
u(τ+1)=fᵤ and
v(τ+1)=fᵥ
for said new pixels, where:
τ is an iteration parameter,
u is pixel information at a pixel,
v is a displacement vector at a pixel describing relative motion between an image in the final image sequence and one or more previous and/or later images in the final image sequence, and
fᵤ and fᵥ are solvers for the equation defining the energy of the final image sequence.

6. A method according to claim 5, wherein for at least one of the new pixels:
fᵤ determines the u(τ+1) value on the basis of one or both of:
(i) values of u for one or more original pixels and/or new pixels within a predetermined area in the current image that includes the position of said at least one of the new pixels, said values of u for the original and new pixels being selected from values of u(τ) and/or u(τ+1), and
(ii) values of u for one or more original pixels and/or new pixels within a predetermined area in one or more previous and/or later images of the image sequence, said predetermined area including a position displaced by v(τ) or v(τ+1) in relation to the position of said at least one new pixel in the current image, said values of u for the original and new pixels being selected from values of u(τ) and/or u(τ+1); and
fᵥ determines the v(τ+1) value on the basis of one or both of:
(i) values of u and v for one or more original pixels and/or new pixels within a predetermined area in the current image that includes the position of said at least one of the new pixels, said values of u and v for the original and new pixels being selected from values of u(τ) and/or u(τ+1) and v(τ) and/or v(τ+1) respectively, and
(ii) values of u and v for one or more original pixels and/or new pixels within a predetermined area in one or more previous and/or later images of the image sequence, said predetermined area including a position displaced by v(τ) or v(τ+1) in relation to the position of said at least one new pixel in the current image, said values of u and v for the original and new pixels being selected from values of u(τ) and/or u(τ+1) and v(τ) and/or v(τ+1) respectively.

7. A method according to claim 5, wherein pixel information values for pixels in the original image sequence are adjusted by iterating:
u(τ+1)=fᵤ
for said pixels in the original image sequence.

8. A method according to claim 5, wherein displacement values for pixels in the original image sequence are adjusted by iterating:
v(τ+1)=fᵥ
for said pixels in the original image sequence.

9. A method according to claim 5, wherein it is assumed that v=0, so that
u(τ+1)=fᵤ is iterated.

10. A method according to claim 5, wherein:
u(τ+1)=fᵤ is iterated a number of times whilst holding fᵥ constant and v(τ+1)=fᵥ is iterated a number of times whilst holding fᵤ constant.

11. A method according to claim 1, wherein the successive images of the final and original image sequences are in the form of frames, and wherein new pixels are added to at least one of the frames of the original image sequence to form a frame of the final image sequence having a greater number of pixels than said at least one of the frames of the original image sequence.

12. A method according to claim 1, wherein the successive images of the final and original image sequences are in the form of frames, and wherein new pixels are used to create a new frame of the final image sequence in which the new frame is between frames of the original image sequence.

13. A method according to claim 1, wherein the successive images of the final image sequence are in the form of frames and the successive images of the original image sequence are in the form of fields, and wherein new pixels are grouped in new rows placed in between rows of fields of the original image sequence to create corresponding frames in the final image sequence.

14. Apparatus for forming a final image sequence, which is formed of a plurality of successive images, from an initial image sequence, which is formed of a plurality of successive images, by adding new pixels to the original image sequence, the apparatus comprising:
one or more processors arranged to define an energy of the final image sequence and its displacement field in terms of one or more of (i) the local spatial distribution of pixel information of at least one pixel, (ii) the local temporal distribution of pixel information of at least one pixel, and (iii) the local spatial distribution of at least one displacement field between two images of said successive images that are displaced in time and the local spatial distribution of pixel information and displacement fields at the position in neighbouring images to which the displacement vector of a new pixel is pointing; and to determine the final image sequence by finding a minimum or nearly-minimum of said energy.

15. Apparatus according to claim 14, wherein the one or more processors are arranged to define the energy of the final image sequence in terms of functionals of one or more of (i) the local spatial distribution of pixel information of at least one pixel, (ii) the local temporal distribution of pixel information of at least one pixel, and (iii) the local spatial distribution of at least one displacement field between two images of said successive images that are displaced in time and the local spatial distribution of pixel information and displacement fields at the position in neighbouring images to which the displacement vector of a new pixel is pointing, the determining step comprising finding a minimum or nearly-minimum of said functionals.

16. Apparatus according to claim 14, wherein the one or more processors are arranged to determine the final image sequence iteratively in which pixel information calculated at a pixel in one iteration is used in the calculation of displacement at said pixel in a subsequent iteration, and displacement calculated at a pixel in one iteration is used in the calculation of pixel information at said pixel in a subsequent iteration.

17. Apparatus according to claim 14, wherein the one or more processors are arranged to determine pixel information and displacement values for said new pixels by:
first estimating an initial value of pixel information and displacement values for said new pixels, and estimating displacement values for pixels in the original image sequence; and,
subsequently obtaining new values of pixel information u and displacement values v for said new pixels by iterating:
u(τ+1)=fᵤ and
v(τ+1)=fᵥ
for said new pixels, where:
τ is an iteration parameter,
u is pixel information at a pixel,
v is a displacement vector at a pixel describing relative motion between an image in the final image sequence and one or more previous and/or later images in the final image sequence, and
fᵤ and fᵥ are solvers for the equation defining the energy of the final image sequence.

18. Apparatus according to claim 17, wherein the one or more processors are arranged such that for at least one of the new pixels:
fᵤ determines the u(τ+1) value on the basis of one or both of:
(i) values of u for one or more original pixels and/or new pixels within a predetermined area in the current image that includes the position of said at least one of the new pixels, said values of u for the original and new pixels being selected from values of u(τ) and/or u(τ+1), and
(ii) values of u for one or more original pixels and/or new pixels within a predetermined area in one or more previous and/or later images of the image sequence, said predetermined area including a position displaced by v(τ) or v(τ+1) in relation to the position of said at least one new pixel in the current image, said values of u for the original and new pixels being selected from values of u(τ) and/or u(τ+1); and
fᵥ determines the v(τ+1) value on the basis of one or both of:
(i) values of u and v for one or more original pixels and/or new pixels within a predetermined area in the current image that includes the position of said at least one of the new pixels, said values of u and v for the original and new pixels being selected from values of u(τ) and/or u(τ+1) and v(τ) and/or v(τ+1) respectively, and
(ii) values of u and v for one or more original pixels and/or new pixels within a predetermined area in one or more previous and/or later images of the image sequence, said predetermined area including a position displaced by v(τ) or v(τ+1) in relation to the position of said at least one new pixel in the current image, said values of u and v for the original and new pixels being selected from values of u(τ) and/or u(τ+1) and v(τ) and/or v(τ+1) respectively.

19. Apparatus according to claim 17, wherein the one or more processors are arranged such that pixel information values for pixels in the original image sequence are adjusted by iterating:
u(τ+1)=fᵤ
for said pixels in the original image sequence.

20. Apparatus according to claim 17, wherein the one or more processors are arranged such that displacement values for pixels in the original image sequence are adjusted by iterating:
v(τ+1)=fᵥ
for said pixels in the original image sequence.

21. Apparatus according to claim 17, wherein the one or more processors are arranged such that it is assumed that v=0, so that:
u(τ+1)=fᵤ is iterated.

22. Apparatus according to claim 17, wherein the one or more processors are arranged such that:
u(τ+1)=fᵤ is iterated a number of times whilst holding fᵥ constant and v(τ+1)=fᵥ is iterated a number of times whilst holding fᵤ constant.

23. Apparatus according to claim 14, wherein the successive images of the final and original image sequences are in the form of frames, and wherein the one or more processors are arranged such that new pixels are added to at least one of the frames of the original image sequence to form a frame of the final image sequence having a greater number of pixels than said at least one of the frames of the original image sequence.

24. Apparatus according to claim 14, wherein the successive images of the final and original image sequences are in the form of frames, and wherein the one or more processors are arranged such that new pixels are used to create a new frame of the final image sequence in which the new frame is between frames of the original image sequence.

25. Apparatus according to claim 14, wherein the successive images of the final image sequence are in the form of frames and the successive images of the original image sequence are in the form of fields, and wherein the one or more processors are arranged such that new pixels are grouped in new rows placed in between rows of fields of the original image sequence to create corresponding frames in the final image sequence.
